(19) United States
(12) Patent Application Publication
(10) Pub. No.: US 2009/0174548 A1
(43) Pub. Date: Jul. 9, 2009

(54) TRACKING SYSTEM

(75) Inventors: Chung Man Chan, Kowloon (HK); Henry Ki Lun Wong, Kowloon (HK); Ching Ching Cheung, Kowloon (HK); Hung Keung Tse, Kowloon (HK)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: Musical Electronics Limited, Kowloon (HK)

(21) Appl. No.: 12/348,423

(22) Filed: Jan. 5, 2009

Related U.S. Application Data
(63) Continuation of application No. 61/018,891, filed on Jan. 4, 2008.

(51) Int. Cl. G08B 1/08

(52) U.S. Cl. 340/539.13

(57) ABSTRACT

A tracking system for monitoring a location of a person and initiating a communication or emitting an alarm if the tracking system is moved outside of a specified area. The tracking system may include a microprocessor module, a location determining module, a communication module and an alarm module. The location determining module determines the location of the tracking system. The communications module transmits and receives data relating to the location of the tracking system. The alarm module emits an alarm notification. The location determining module, the communications module and the alarm module are operably connected to the microprocessor module.

### REFERENCE TO RELATED APPLICATION

Priority is claimed to U.S. Provisional Applic. No. 61/018,891, filed Jan. 4, 2008, the contents of which are hereby incorporated herein by reference.

### FIELD OF THE INVENTION

The invention relates generally to a personal safety product. More particularly, the invention relates to a tracking system applicable to pets, cars, assets and persons.

### BACKGROUND OF THE INVENTION

As society evolves and transportation systems improve, there is a greater likelihood that persons will need to monitor the whereabouts of their junior or senior family members when allowing them free mobility. For example, the children at a very young age like to walk around the neighborhood at will and without boundaries. Especially when the transportation system is readily accessible in a city area, there is a greater likelihood that the family members cannot find the whereabouts of the children from time to time.

It is not always possible for another person to watch the young children, or in some cases, older family members with deteriorating physical or mental abilities, such that it can be immediately communicated to the family members/friends their whereabouts when a danger has occurred or when the situation requires.

Several U.S. patents and patent publications disclose systems for tracking the whereabouts of a person, an animal or an object. Examples of these references include Fraker et al., U.S. Pat. No. 5,919,239; Copley et al., U.S. Pat. No. 7,105,817; Berard et al., U.S. Pat. No. 5,515,043; Honda et al., U.S. Pat. No. 6,614,394; and Troxler, U.S. Pat. No. 7,034,695.

Each of these tracking system uses GPS data or radio station data that is indicative of the whereabouts of a person, a pet or an object, such as a car. The tracking systems also generally include a system for notifying others of the whereabouts of such person, a pet or an object carrying a tracking system.

### SUMMARY OF THE INVENTION

The tracking system is carried by a person, a pet or a moving object to allow users to monitor the physical location(s) of the carrier of the tracking system. When it detects the whereabouts of its carrier, it transmits such information to a remote user terminal. Depending on the configuration of the system, the transmissions may be periodic and such transmissions may be initiated by the tracking system or by input external to the tracking system. A memory device stores such time-series sets of information. The remote user terminal is adapted with computer software and plots the travel path of the carrier. If the carrier is outside a predetermined zone, the tracking system sends a warning signal to the user terminal. The tracking system also may be used together with other alarm devices, such as a fall detector device or car antitheft alarm system.

### BRIEF DESCRIPTION OF THE DRAWINGS

FIG. 1 is a perspective view of a tracking system according to an embodiment of the invention that is adapted for clipping on to a person's clothes.

FIG. 2 is a front view of the tracking system of FIG. 1.

FIG. 3 is a side view of the tracking system of FIG. 1.

FIG. 4 is a top view of the tracking system of FIG. 1.

FIG. 5 is a bottom view of the tracking system of FIG. 1.

FIG. 6 is a front view of an alternative embodiment of the tracking system.

FIG. 7 is a back view of the tracking system of FIG. 6.

FIG. 8 is a side view of the tracking system of FIG. 6.

FIG. 9 is a top view of the tracking system of FIG. 6.

FIG. 10 is a bottom view of the tracking system of FIG. 6.

FIG. 11 is a block diagram of aspects of the tracking system.

### DETAILED DESCRIPTION OF THE PREFERRED EMBODIMENTS

The invention is a tracking system, as illustrated at 10 in the Figures. The tracking system 10 thereby facilitates providing location information and emergency signal to others and helps others to get to the carrier of the tracking system 10 in need in shorter time.

The tracking system 10 generally includes an outer enclosure 18 in which the components of the tracking system 10 are contained. The outer enclosure 18 may be fabricated from a variety of materials depending on the desired appearance of the tracking system 10 and the conditions under which the tracking system 10 is to be used. In one configuration, the outer enclosure 18 is fabricated from injection molded plastic.

To enhance the simplicity of using the tracking system 10, the outer enclosure 18 has a minimal amount of controls. A panic button 20 may occupy a relatively large portion of at least one surface of the outer enclosure 18 or a relatively easily accessible portion of at least one surface of the outer enclosure 18 to enhance the ability to depress the panic button 20 in case of an emergency.

It is also possible to use the tracking system for tracking the location of objects such as vehicles and animals such as dogs. It will be appreciated that when used in such applications, the tracking system 10 may have slightly different configurations to facilitate attaching the tracking system 10 to the object whose location is being tracked.

A stop button 22 may also be provided on the outer enclosure 18. The stop button 22 may be disposed in another portion of one surface of the outer enclosure 18. Forming the stop button 22 in this manner reduces the potential that the tracking system 10 may be inadvertently deactivated when in the panic mode.

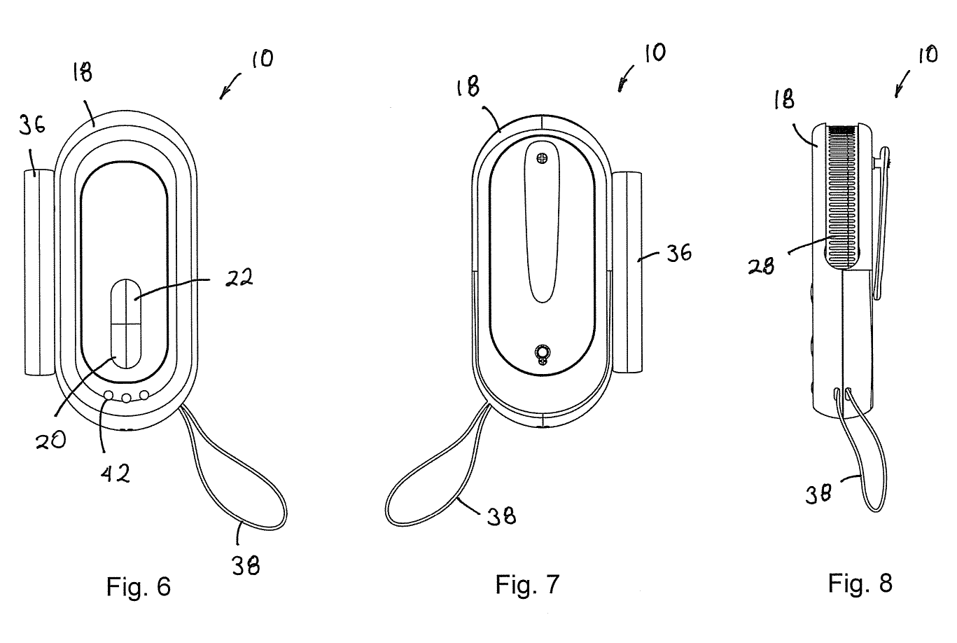

Inside of the outer enclosure 18 components necessary for the operation of the tracking system 10 are located. The components may include a microprocessor 40 adapted to be capable of acquiring location information from the GPS satellites 30, a remote user terminal 32 receiving the location information, a memory device for storing the carrier's ID information and location information, an emergency request device for instructing the tracker system 10 sending out a getting help signal, a location determining device, and a message transmission device, as illustrated in FIG. 6.

In one embodiment, the memory device is an internal memory unit. Alternatively, the memory device is added with or is an external memory or a removable memory device, such as a SD memory card. In one embodiment, the location determining device is a GPS module, which can receive communications from at least one GPS satellite 30.

In one embodiment, the message transmission device is capable of emitting a wireless signal and such device is a public radio communication network 34, which can be a GSM module, a GPRS module or, alternatively a 3G module. To enhance the mobility of the tracking system 10, the components of the tracking system 10 may be powered by battery. The tracking system 10 may include the ability to recharge the battery.

The tracking system 10 is adaptable to attachment to the person using a variety of configurations. An important criterion would be that the method of attaching the tracking system 10 to the person's body is that the attachment mechanism resists inadvertent detaching from the person, as inadvertent detaching could lead to false alarms and/or damage to the tracking system 10.

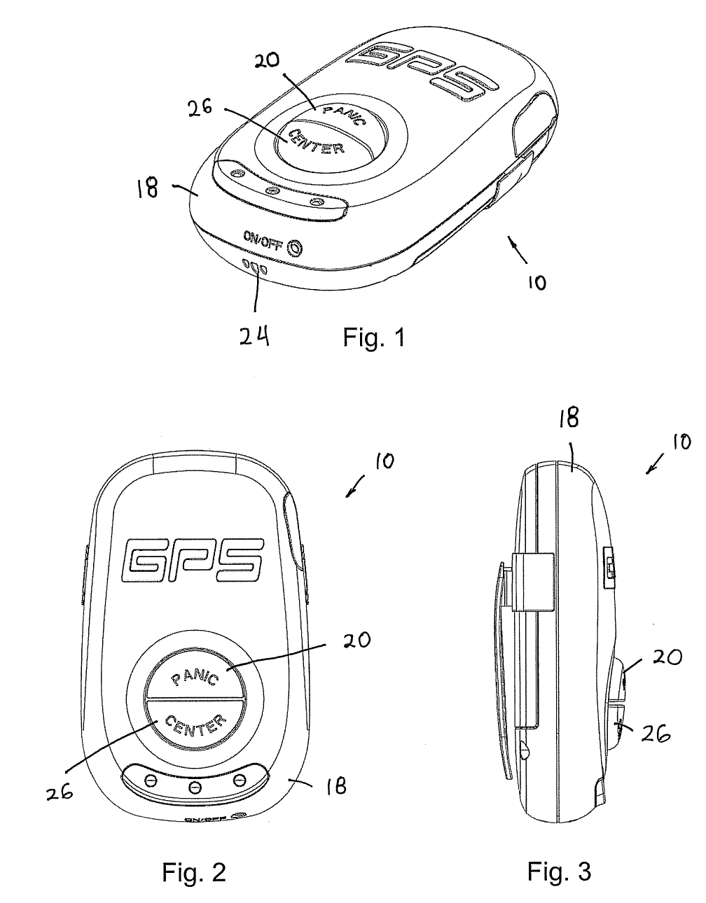

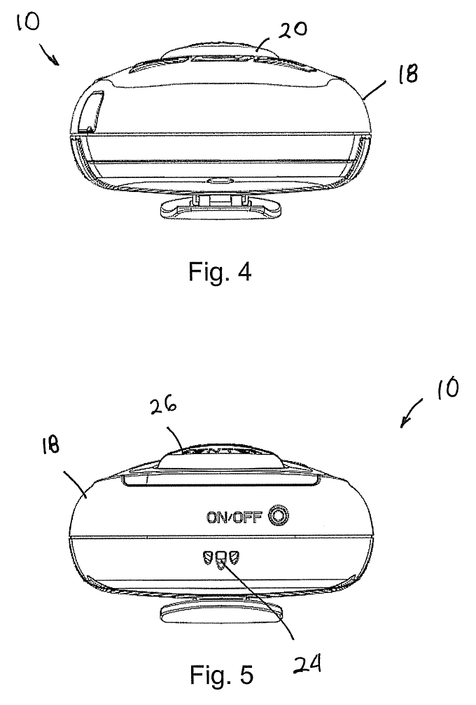

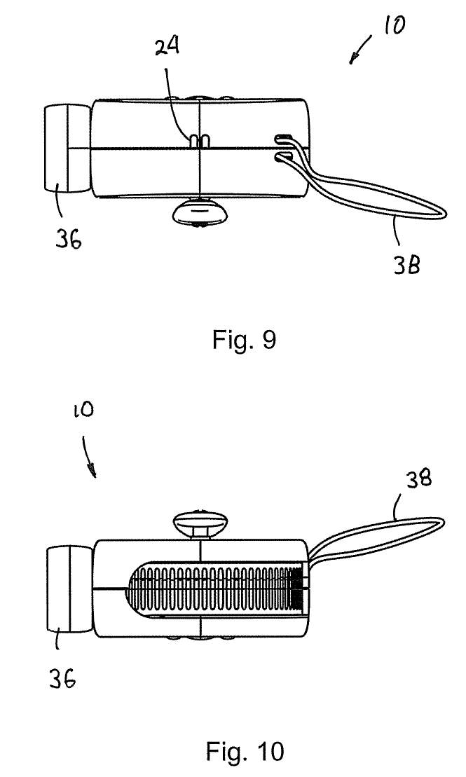

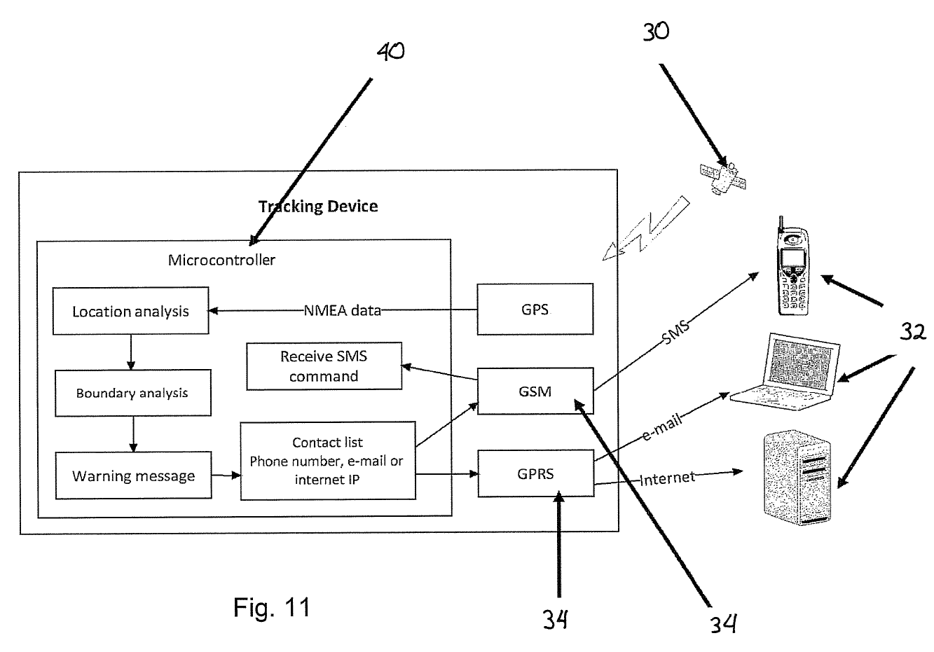

Two particular configurations include clipping on a person's clothing (as illustrated in FIGS. 1-5) and hand carrying (as illustrated in FIGS. 6-10). The tracking system 10 may also be attached to other portions of the person's body such as the arm with a strap. The tracking system 10 may facilitate readily changing between attachment mechanisms such as when the activity being performed by the person is changed.

The tracking system 10 may monitor movement and/or orientation of the carrier of the tracking system 10. For example, the tracking system 10 is adapted to send to the remote user terminal 32, which can be a mobile phone, PDA or computer, location information, obtained by the global coordinates by satellite signal, on an intermittent basis over a period of time. Alternatively, the memory device stored the time-series sets of the location data together with time data.

The tracking system 10 is then sent to the remote user terminal 32 the stored time series sets of the location data on a preset intermittent basis over a period of time. The remote user terminal 32 uses a map plotting device adapted to use the coordinates information to plot the traveling path of the carrier. In one embodiment, the user can input the coordinates to an online map and check the location of the carrier.

The tracking system 10 then transmits the location information with address, time information and travel path on the map to the remote user terminal 32 direct. It eliminates a calculation circuitry or operations at the sides of the users. Further or alternatively, the user may send a SMS request for the location of the carrier of the tracking system via a mobile phone, PDA or computer. The message transmission device transmits such request to the tracking system 10. The microprocessor 40 is adapted to send out the location information back to the user via the message transmission device.

Alternatively or additionally, the tracking system 10 may also detect when the carrier moves outside of a preset boundary in the manner that is indicative of the carrier losing direction or venturing into unknown or dangerous zone.

In operation, the tracking system 10 is enabled by attaching the tracking system 10 to a person using one of the mechanisms set forth above. If the carrier remains outside a predetermined boundary for the first selected period of time, a sound alarm, such as a buzzer 24 is initiated to alert the carrier he/she is outside a safe zone.

A light may also accompany the sound alarm. In one embodiment, the light is a LED 42. Such light may be in a preset color or a pattern of intensity.

If the sound alarm remains on for more than a selected period of time, the tracking system 10 may transmit a message such as using SMS or email that contains information about the carrier such as the carrier's name and location as determined by the GPS module. In one configuration, the selected period of time is less than about 60 seconds and preferably is about 30 seconds.

In one embodiment, the tracking system 10 is adapted to activate the sound alarm 24 and/or send out a warning message to the users when it detects the carrier is within a preset proximal range of the predetermined boundaries by calculating the distance between coordinates of the predetermined boundaries and of the preset proximal range.

In another operation, the emergency request device is a panic button 20. When the panic button 20 is pressed, the tracking system 10 sends a warning message to others in a selected period of time. Such time is less than 30 seconds and preferably is about 15 seconds. The tracking system 10 thereby provides a relatively short period of time for the carrier to press the stop button 22 such as if the tracking system 10 was inadvertently activated.

The sound alarm, in one embodiment the buzzer 24, is activated upon pressing the panic button 20.

The location information and the travel path will be displayed on the devices of the remote user terminal 32 receiving such information. The remote user terminal 32 can be a mobile phone or a PDA with map display or a computer.

The message may be transmitted using a variety of communication protocols such as GSM and GPRS. The message may be transmitted over a public communication network, a private communication network, or combination thereof.

Alternatively or additionally, the message may be transmitted via a computer network such as the internet such that the message may be viewed on a remote computer system.

The tracking system 10 may continue to transmit messages regarding the location information and travel path at selected intervals. In one configuration, the selected intervals are 30 seconds.

In one embodiment, the preset boundaries is set by the user by inputting at least three selected sets of coordinates to online map to define the boundaries. It is preferred that no limit is set to the number of selected sets of coordinates. Therefore, the boundaries are not limited to any shape but determined by the selected coordinates.

Alternatively, the user input at least one location, be it a set of coordinates or a place on online map, and further input a radius unit and thereby, defining the boundaries within the selected radius about such location, as a center. The user may set the center from time to time by pressing the center button 26. Alternatively, the user may set the center or input GPS data and device configuration by a computer connected to the tracking system 10 via USB 28.

As an alternative to activating the center button 26 by pressing the center button 26, a security device may be utilized to prevent inadvertent activation of the center button 26. For example, it may be required to press the center button 26 for more than a specified period of time to activate the center button. The security device may also include pressing at least one additional button in conjunction with the center button 26 to activate the center button. The at least one additional button may be pressed at the same time as the center button 26, prior to pressing the center button 26 or after pressing the center button 26.

In one embodiment, the tracking system can be installed in a car, and adapted to have all functions of the tracking system carried by a person. The tracking system in the car sends location information and travel path to the microprocessor 40 and the user may through his mobile phone, PDA or computer obtain such information. It can be served as a device against car theft.

In one embodiment, the tracking system 10 is installed in or with a fall detector. When a fall event is detected by the fall detector by sensing the carrier lying down for a time period over a preset duration, the sound alarm of the tracking system 10 is activated. Unless the carrier presses a stop button 22 within a predetermined time, a higher volume alarm is further activated and the tracking system 10 sends preset warning message carrying location information to a predetermined contact list, such as the remote user terminal 32.

In one embodiment, the tracking system 10 is equipped with a detachable pill-box 36. In one embodiment, a detachable pill-box 36 is disposed at one lateral side of the tracking system 10 (as shown in FIGS. 6-7). An elderly can carry the tracking system 10 with the features described above for location tracking, emergency messenger and, carrying pills in the detachable pill-box 36. The tracking system 10 is also added with a carrying strap for easy carrying.

It is contemplated that features disclosed in this application, as well as those described in the above applications incorporated by reference, can be mixed and matched to suit particular circumstances. Various other modifications and changes will be apparent to those of ordinary skill.

1. A tracking system comprising:
a microprocessor module;
a location determining module for determining the location of the tracking system, wherein the location determining module is operably connected to the microprocessor module;
a communications module for transmitting and receiving data relating to the location of the tracking system, wherein the communications module is operably connected to the microprocessor module; and
an alarm module for emitting an alarm notification, wherein the alarm module is operably connected to the microprocessor module.

2. The tracking system of claim 1, and further comprising a memory module that is operably connected to the microprocessor module.

3. The tracking system of claim 1, and further comprising a container attached thereto, wherein the container has a receptacle in which at least one object may be stored.

4. The tracking system of claim 1, and further comprising an orientation sensor module to monitor orientation of the tracking system, wherein the orientation sensor module is operably connected to the microprocessor module.

5. The tracking system of claim 1, and further comprising a motion sensor module to monitor movement of the tracking system, wherein the motion sensor module is operably connected to the microprocessor module.

6. The tracking system of claim 1, wherein the communication module is capable of receiving and transmitting over at least one frequency.

7. The tracking system of claim 1, wherein the location determining module is capable of receiving data from at least one satellite, at least one antenna or combination thereof.

8. A method of tracking the location of a person using a tracking system, wherein the method comprises:
attaching a tracking system to a person whose location is to be tracked;
activating an alarm by pressing a panic button on the tracking system, wherein the panic button is operably connect to the microprocessor module;
determining a location of the tracking system with a location tracking module, wherein the location tracking module is operably connected to the microprocessor module;
emitting an alarm from an alarm module, wherein the alarm module is operably connected to the microprocessor module; and
initiating a communication with a communications module, wherein the communications module is operably connected to the microprocessor module.

9. The method of claim 8, and further storing data relating to time and location in a memory module, wherein the memory module is operably connected to the microprocessor module.

10. The method of claim 9, and further comprising transmitting the time and location data.

11. The method of claim 8, wherein the alarm is capable of emitting a sound, emitting a light, initiating a transmission or combination thereof.

12. The method of claim 11, wherein initiating a transmission comprises initiating a telephone call, sending a text message, sending an email, posting a notice on an internet site or combination thereof.

13. The method of claim 8, and further comprising
setting an initial location of the tracking system;
monitoring a location of the tracking system; and
activating the alarm module when the tracking system is moved more than a specified distance from the initial location.

14. The method of claim 8, and further comprising attaching a container to the tracking system, wherein the container has a receptacle in which at least one object may be stored.

15. The method of claim 8, and further comprising monitoring orientation of the tracking system with an orientation sensor module, wherein the orientation sensor module is operably connected to the microprocessor module.

16. The tracking system of claim 1, and further comprising monitoring movement of the tracking system with a motion sensor module, wherein the motion sensor module is operably connected to the microprocessor module.

17. The tracking system of claim 1, wherein monitoring movement of the tracking system includes monitoring acceleration of the tracking system, which is indicative of a fall.

18. The tracking system of claim 8, wherein communicating is done over a wireless telephone network, a wired telephone network, a wireless computer network, a wired computer network, or combination thereof.
